(19) United States
(12) Patent Application Publication
(10) Pub. No.: US 2004/0056891 A1
(43) Pub. Date: Mar. 25, 2004

(54) Content delivery apparatus and computer program therefor

(75) Inventor: Satoshi Hiratsuka, Hamamatsu-shi (JP)

Correspondence Address: David L. Fehrman, Morrison & Foerster LLP, 555 W. 5th Street, Los Angeles, CA, 90013, US

(73) Assignee: YAMAHA CORPORATION, Hamamatsu-shi (JP)

(21) Appl. No.: 10/665,043

(22) Filed: Sep. 17, 2003

(30) Foreign Application Priority Data
Sep. 24, 2002 (JP) 2002-276592

(51) Int. Cl. G09G 5/00

(52) U.S. Cl. 345/744

(57) ABSTRACT

Content delivering server has first content materials of a first format and second content materials stored in its memory. If a requesting client terminal to which content is to be delivered is of a type capable of using the first content material of the first format, the server creates single composite content including the first and second content materials. If the requesting client terminal to which content is to be delivered is of a type incapable of using the first content material of the first format, the server converts the first content material of the first format into a first content material of a second format capable of being used by the client terminal to thereby create single composite content including the converted first content material of the second format and the second content material, and then it delivers the thus-created content to the client terminal.

### BACKGROUND OF THE INVENTION

The present invention relates to an improved content delivery system which allows composite content, including a content material that has to be varied in format depending on types of client terminals, to be appropriately delivered from a content delivering server to each requesting client terminal.

There have been known content delivering servers which deliver content to client terminals, such as personal computers and portable communication terminal devices. Particularly, content delivering servers, which deliver content to requesting client terminals after converting the format of the content depending on types of the client terminals, are proposed, for example, in Japanese Patent Laid-open Publication No. 2001-195068 and European Patent Laid-open Publication No. EP1073034A2 which is a counterpart of the Japanese Patent Laid-open Publication.

Such a conventionally-known content delivery technique concerns non-composite content including one content material, such as an incoming-call signaling melody (ring melody) for a portable phone, and no reference has been made to composite content including a plurality of content materials.

### SUMMARY OF THE INVENTION

In view of the foregoing, it is an object of the present invention to provide a content delivery apparatus and computer program therefor which allow composite content, including a content material that has to be varied in format depending on types of client terminals, to be appropriately delivered from a server to each requesting client terminal.

According to a first aspect of the present invention, there is provided a content delivery apparatus, which comprises: a storage section that stores at least one first content material and at least one second content material, the first content material being of a first format; a client terminal identification section that determines a type of a client terminal to which content is to be delivered; a first content creation section that, on the basis of a determination, by the client terminal identification section, that the client terminal to which content is to be delivered is of a type capable of using the first content material of the first format, creates single composite content including the first content material of the first format and the second content material; a second content creation section that, on the basis of a determination, by the client terminal identification section, that the client terminal to which content is to be delivered is of a type incapable of using the first content material of the first format, converts the first content material of the first format into a first content material of a second format capable of being used by the client terminal and then creates single composite content including the converted first content material of the second format and the second content material; and a content delivery section that delivers, to the client terminal, the composite content created by the first content creation section or the second content creation section.

In a content delivery system employing the content delivery apparatus of the present invention, at least one first content material of the first format and at least one second content material are stored in the content material storage section. If a requesting client terminal, to which content is to be delivered, is of a type capable of using the first content material of the first format, single composite content including the first content material of the first format and the second content material is created and delivered to the client terminal. If, on the other hand, the requesting client terminal, to which content is to be delivered, is of a type incapable of using the first content material of the first format but capable of using the first content material of a second format, then the first content material of the first format is converted into the second format to thereby create single composite content including the converted first content material of the second format and the second content material, and the thus-created composite content is delivered to the client terminal.

With the present invention thus arranged, composite content, including a content material varied in format depending on types of client terminals, can be appropriately delivered from the content delivery apparatus to each requesting client terminal. Particularly, the present invention achieves the superior technical benefit that the necessary storage capacity of the content material storage section in the delivery apparatus can be dramatically reduced.

According to a second aspect of the present invention, there is provided a content delivery apparatus, which comprises: a storage section that stores at least one first content material of a first format and at least one second content material; a client terminal identification section that determines a type of a requesting client terminal to which content is to be delivered; a content creation section that, on the basis of a determination by the client terminal identification section about the type of the client terminal, converts the first content material of the first format into a first content material of a second format capable of being used by the client terminal and then creates single composite content including the converted first content material of the second format and the second content material; and a content delivery section that delivers, to the client terminal, the composite content created by the content creation section.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an exemplary hardware setup of a server computer in a content delivery system in accordance with an embodiment of the present invention;

FIG. 2 is a schematic functional block diagram of the content delivery system of FIG. 1; and

FIG. 3 is a flow chart showing an example of processing performed in the content delivery system.

### DETAILED DESCRIPTION OF EMBODIMENTS

[Outline of Content Delivery System]

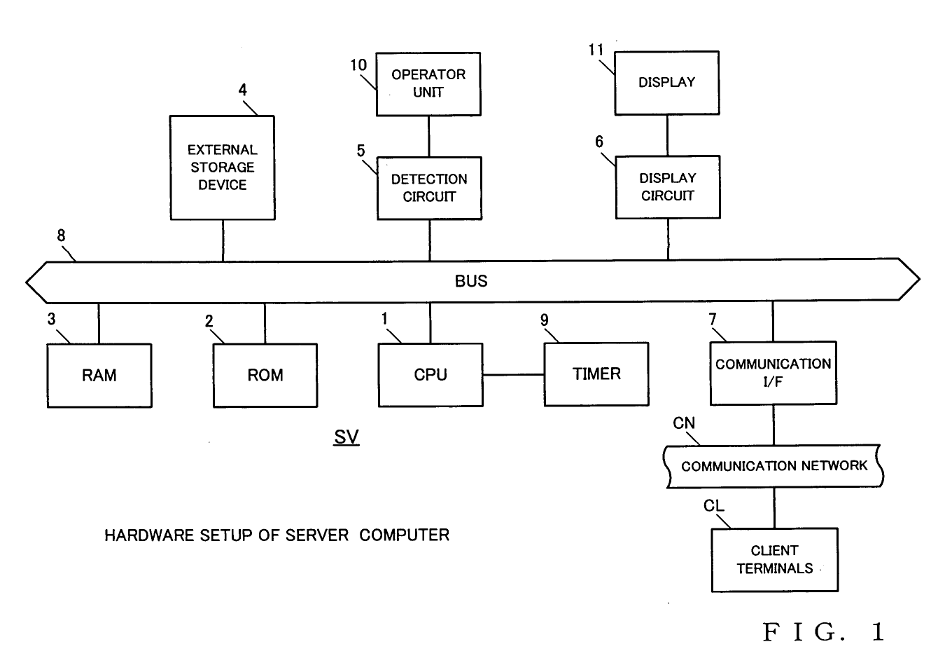

Content delivery system constructed in accordance with an embodiment of the present invention comprises a content delivering server (server computer) SV, a wide-area communication network CN, such as the Internet, a plurality of client terminals, such as personal computers PC and electronic musical instruments KB having communication functions, portable communication terminals, etc. FIG. 1 is a block diagram showing an exemplary hardware setup of the server computer SV in the embodiment of the content delivery system.

In FIG. 1, the server computer, constituting the content delivering server SV, includes a central processing unit (CPU) 1, a read-only memory (ROM) 2, a random-access memory (RAM) 3, an external storage device 4, an operation detection circuit 5, a display circuit 6, a communication interface (I/F) 7, etc. These components 1-7 are interconnected via a bus 8.

The CPU 1 primarily performs various control and various processing, such as content delivery and processes related thereto, using clock pulses generated by a timer 9 and in accordance with predetermined software programs. To perform the content delivery processing, the CPU 1 performs a function of generating composite content (Pd, Kd or the like) that includes a plurality of content materials, such as MIDI (Musical Instrument Digital Interface) data (Nd) and musical score data (Md1 or Md2), as will be later described. For such purposes, the ROM 2 has prestored therein various server control programs, such as a content delivery processing program, and various control parameters. The RAM 3 is used as a working area for storing data and parameters necessary for various processes.

The external storage device 4 comprises any of a hard disk drive (HDD) and removable, portable storage media, such as a compact disk read-only memory (CD-ROM), flexible disk (FD), magneto-optical (MO) disk, digital versatile disk (DVD) and semiconductor memory. The external storage device 4 has prestored therein a multiplicity of content materials, such as MIDI data and musical score data, and other electronic music information. The external storage device 4 can also prestore data related to content delivery, such as client information (client database), and a content delivery processing program.

The operation detection circuit 5 detects operation performed via an operator unit 10, including a mouse, character (alphanumeric) keyboard, etc, connected to the operation detection circuit 5, and introduces data indicative of the detected operation into the server SV to set an operating state of the server SV. The display circuit 6 controls a display 11 connected thereto in accordance with instructions given from the CPU 1, so that the display 11 visually displays operating states and settings of the server SV.

To the communication I/F 7 is connected a communication network CN, such as the Internet, via which the content delivering server SV can communicate with any one of various types of client terminals CL. The server SV can deliver, to any one of the client terminals CL, composite content as mentioned above, or other composite content that includes a main musical content material, such as MIDI data (Nd), and an additional content material, such as video data or sound waveform data (i.e., waveform data of sounds that may include voices) attached to the main musical content material. The additional content material attached to the main musical content material may be any desired material corresponding to the main musical content material, such as practicing (e.g., fingering) data, teaching (advising) data, karaoke data or the like. Note that the server SV in the instant embodiment may be one functioning as both a content delivery site specialized in musical information and a site for delivering character information, such as news, and/or image information, such as images to be used as standby screens of portable phones.

Each of the client terminals CL can download and use composite content (Pd, Kd) including a plurality of content materials, such as MIDI data (Nd) and musical score data (Md1 or Md2). Various types of client terminals are employed in the instant embodiment, which may include not only personal computers PC having music information processing functions and electronic musical instruments KB like electronic keyboard instruments, but also electronic music devices capable of processing composite content, such as musical game devices, karaoke devices, portable communication terminals like portable phones and terminals for selling portable musical information storage media.

Although not specifically shown in the drawings, each of the client terminals CL includes a tone generation section in addition to hardware components that are generally similar to those of the server SV FIG. 1. Each of the client terminals CL may include any other component specific to that client terminal as necessary; for example, in the case of the portable communication terminal, it may include transmitter/receiver means. The tone generation section includes a MIDI tone generator circuit, an effect circuit including a DSP (Digital Signal Processor), a sound system including a D/A converter, amplifier and speaker, etc. The tone generation section thus arranged can generate tones on the basis of musical information that is contained in composite content delivered from the server SV or stored in the client terminal CL in question. Further, on the display of the client terminal CL, there can be displayed images on the basis of musical score data and image information contained in composite content delivered from the server SV, or various image information stored in the client terminal CL in question.

[Function of the System]

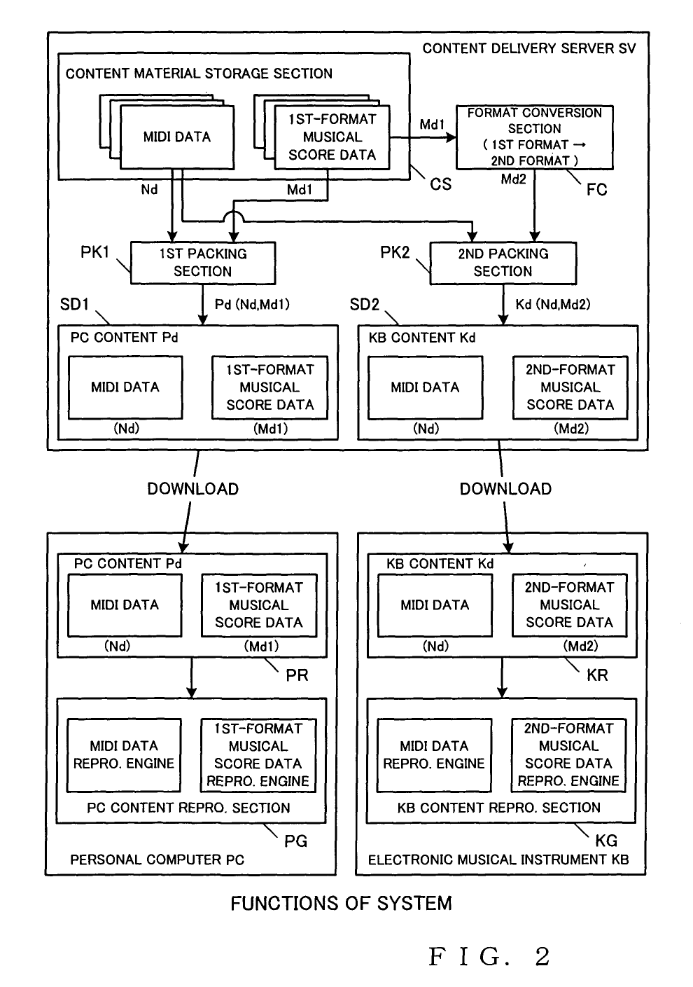

FIG. 2 is a schematic functional block diagram of the content delivery system of FIG. 1. In the content delivery system, the client terminals CL, such as personal computers PC and electronic musical instruments KB, are arranged to use composite content Pd, Kd including a plurality of content materials like MIDI data Nd and musical score data Md1, Md2; for such purposes, the content delivering server SV includes a content material storage section CS prestoring a multiplicity of content materials, such as MIDI data Nd and musical score data Md1.

The content material storage section CS has prestored therein a multiplicity of MIDI data Nd and musical score data Md1 as content materials. The musical score data Md1 are prestored in a private format and will hereinafter be called “first-format musical score data”. The “first-format musical score data” are supplied by given content makers or other producers that produce content using a content producing device provided by the given content makers, and the format of the first-format musical score data is not opened to third parties, such as an electronic musical instrument manufacturer, that provide the electronic musical instrument KB. The non-publicly-opened or private format will hereinafter be called a “first format”. The MIDI data Nd, on the other hand, are stored in a publicly-opened format, and content makers of the MIDI data Nd are not limited to the above-mentioned given makers.

Each of the personal computers PC in the content delivery system has installed therein content reproducing software that comprises a MIDI data reproducing engine and first-format musical score data reproducing engine, which constitutes a PC content reproduction section PG. Of the content reproducing software, at least the first-format musical score data reproducing engine is software that is supplied by any of the content makers of the first-format musical score data Md1. The MIDI data reproducing engine may be supplied either by any one of the content makers of the first-format musical score data Md1 or by another party, such as the manufacturer of the electronic musical instrument KB.

Each of the electronic musical instruments KB in the content delivery system has installed therein content reproducing software that comprises a MIDI data reproducing engine and second-format musical score data reproducing engine, which constitutes an electronic-musical-instrument (KB) content reproduction section KG. The content reproducing software is provided by the manufacturer of the electronic musical instrument KB. Namely, because the manufacturer of the electronic musical instrument KB does not employ the first format of the musical score data Md1, no engine capable of reproducing the first-format musical score data Md1 can be provided by the manufacturer of the electronic musical instrument KB. Therefore, the KB content reproduction section KG incorporated in the electronic musical instrument KB is provided with the second-format musical score data reproducing engine for reproducing musical score data Md2 of a format employed by the manufacturer of the electronic musical instrument KB (hereinafter called a “second format” and the musical score data Md2 will be called “second-format musical score data Md2”).

Because, as set forth above, the musical score data handled by the electronic musical instrument KB are the second-format musical score data Md2 rather than the first-format musical score data Md1 and the second-format musical score data Md2 can be reproduced by the KB content reproduction section KG, the content delivering server SV in the system is provided with a format conversion section FC for converting the first-format musical score data Md1 into second-format musical score data Md2. Once any one of the electronic musical instruments KB has requested downloading of given content, the server SV retrieves MIDI data Nd and first-format musical score data Md1, corresponding to the requested content, that are stored in the content material storage section CS, and the server SV converts the retrieved musical score data Md1 from the first format to the second format in real time by means of the format conversion section FC.

In a case where content Pd including the first-format musical score data Md1 and content Kd including the second-format musical score data Md2 is prepared separately in advance in the content material storage section CS, an extremely poor efficiency would be encountered because there is a need to include same MIDI data Nd in both of the content Pd and Kd. However, in the instant embodiment, real-time conversion by the format conversion section FC can eliminate a need for storing the second-format musical score data Md2 and can thus reduce a necessary storage capacity of the content material storage section CS.

Particularly, when given content is to be delivered to any one of the client terminals CL, the content delivering server SV in the instant embodiment causes a first or second packing section PK1 or PK2 to pack a plurality of content materials, such as MIDI data Nd and first-format or second-format musical score data Md1 or Md2, to create composite content Pd or Kd containing the plurality of content materials ((Nd and Md1) or (Nd and Md2)). With this arrangement, the instant embodiment can dramatically reduce the necessary storage capacity of the content material storage section CS.

Specifically, If the requesting client terminal CL is a personal computer PC, the first packing section PK1 packs MIDI data Nd and first-format musical score data Md extracted, as content materials, from the content material storage section CS, to create single composite content Pd (Nd and Md1). If the requesting client terminal CL is an electronic musical instrument KB, the second packing section PK2 packs MIDI data Nd from the content material storage section CS and second-format musical score data Md2 from the format conversion section FC, to create single composite content Kd (Nd and Md2). In the instant embodiment, the content materials to be packed together are sets of data corresponding to each other in musical contents, like MIDI data and musical score data of a same music piece.

The PC content (content for a personal computer) Pd and KB content (content for an electronic musical instrument) Kd packed by the first and second packing sections PK1 and PK2 are downloaded respectively from first and second content transmission sections SD1 and SD2 to a PC content reception section PR of the personal computer PC and a KB content reception section KR of the electronic musical instrument KB. Then, the PC content Pd or KB content Kd downloaded to the personal computer PC or electronic musical instrument KB is reproduced by the PC content reproduction section PG or KR content reception section.

Each of the PC content Pd and KB content Kd output from the packing sections PK1 and PK2 is in the form of a single file, which is encrypted and thus can be decrypted and reproduced only by the PC content reproduction section PG or KB content reproduction section of the electronic musical instrument KB which has purchased the content; the content Pd or Kd can not be reproduced by any other reproduction device than the PC content reproduction section PG or KB content reproduction section. With such an arrangement, unauthorized use of the content can be reliably prevented.

As set forth above, the delivering server SV in the embodiment of the content delivery system has the functions of: prestoring first content materials Md1 of the first format and second content materials Nd in the content material storage section CS; when a requesting client terminal CL to which content is to be delivered is a PC capable of using a first content material Md1 of the first format, creating single composite content Pd, including the first content material Md1 of the first format and second content material Nd, by means of the first packing section PK1 and delivering the thus-created composite content Pd to the requesting client PC by means of the first content transmission section SD1; and when the requesting client terminal CL to which content is to be delivered is an electronic musical instrument KB incapable of using a first content material Md1 of the first format, converting, by means of the format conversion section FC, the first content material Md1 of the first format into a first content material Md2 of the second format usable by the client KB, creating single composite content Kd, including the first content material Md2 of the second format and second content material Nd, by means of the second packing section PK2 and delivering the thus-created composite content Kd to the requesting client KB by means of the second content transmission section SD2.

[Operational Flow]

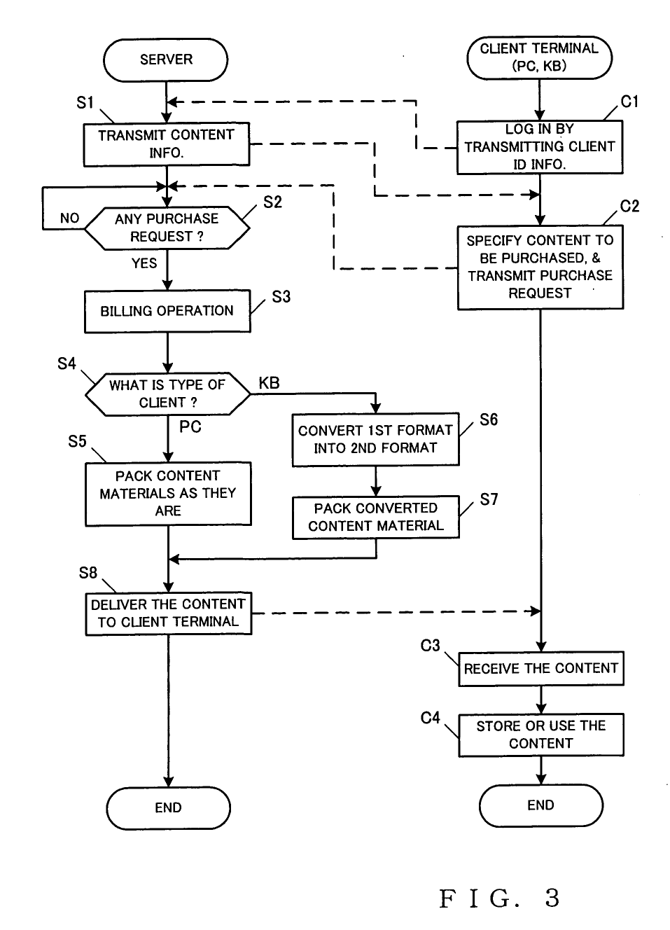

FIG. 3 is a flow chart showing an example of processing performed in the embodiment of the content delivery system. When a client user, wanting delivery of content, has manipulated predetermined operators to cause the client terminal CL to transmit its client identification information to the server SV along with a password and the client identification information and password has been confirmed by the server SV, the system is placed in a log-in state (step C1). Then, the server SV returns a listing of titles of deliverable composite contents to the client terminal CL at step S1 and waits for a purchase request from the client terminal CL at step S2.

The listing transmitted from the server SV is displayed on the display of the client terminal CL. When the user has selected from the displayed listing content to be downloaded, a purchase request for the selected content is transmitted from the client terminal CL to the server SV at step C2. Once the purchase request is received (YES determination at step S2), the server SV carries out a billing operation to charge the client terminal CL for the requested composite content, at step S3. Then, at step S4, the server SV searches a client database in accordance with the client identification information and thereby identifies the type of the client terminal CL.

If the server SV has determined that the client terminal CL, having requested purchase of the content, is a client terminal having the first-format musical score data reproducing function, i.e. a personal computer (“PC” at step S4), the first packing section PK1 packs together corresponding MIDI data Nd and first-format musical score data Md1, extracted from the content material storage section CS as content materials constituting the requested composite content, as they are (step S5). Then, at step S8, composite content Pd for a PC, having been created by the packing, is delivered from the first content transmission section SD1 to the client terminal CL.

If, on the other hand, the server SV has determined that the client terminal CL, having requested purchase of the content, is a client terminal having no first-format musical score data reproducing function, i.e. an electronic musical instrument (“KB” at step S4), the server SV searches the client database in accordance with the client identification information and thereby determines that the musical score reproducing function of the client terminal is the second-format musical score data reproducing function. Thus, at step S6, the format conversion section FC converts the first-format musical score data Md1, extracted as a content material, into second-format musical score data Md2 reproducible by a second-format image data reproducing engine provided in the electronic musical instrument. Then, at step S7, the second packing section PK2 packs the converted second-format musical score data Md2 along with MIDI data Nd extracted as another content material. At next step S8, composite content Kd for an electronic musical instrument KB, having been created by the packing, is delivered from the second content transmission section SD2 to the client terminal CL.

After the composite content Pd or Kd transmitted from the server SV has been received via the content reception section PR or KR at step C3, the client terminal CL can store or use the received composite content Pd or Kd, at step C4. For example, the received composite content Pd or Kd can be stored in the storage device, or tones based on the received composite content Pd or Kd can be generated by the tone generation section, during which time a musical score corresponding to the currently-generated tones can be displayed on the basis of the musical score data Md1 or Md2.

[Various Modifications]

The preferred embodiment having been described above with reference to the drawings is just illustrative, and various modifications of the present invention are also possible without departing from the basic principles of the invention. For example, content materials of composite content are not limited to MIDI data Nd and musical score data Md1 or Md2 as described above, and the composite content may include other content materials, such as audio data, video data and/or teaching data. The composite content may comprise any desired combination of such content materials. In any case, it is only necessary that composite content to be delivered to a requesting client terminal should be created by converting at least one of content materials into another format corresponding to the type of the client terminal.

Further, the billing operation to be performed for a content purchase request may be arranged to charge a fixed amount corresponding to the contents of the content irrespective of whether or not the content has to be converted in format (step S6 of FIG. 3), or vary the charged amount depending on whether or not the content has to be converted in format. In the latter case, it is better for the billing operation to be performed after identification of the type of the client terminal (step S4), i.e. before delivery of the content to the client terminal (S8).

Furthermore, the first and second packing sections PK1 and PK2 employed in the above-described embodiment may be replaced with a single packing section.

In summary, the present invention is characterized by: prestoring first content materials of the first format and second content materials in the content material storage section; when a requesting client terminal, to which content is to be delivered, is one capable of using a first content material of the first format, creating single composite content including the first content material of the first format and second content material and delivering the thus-created composite content to the client terminal; and when the requesting client terminal, to which content is to be delivered, is one incapable of using a first content material of the first format, converting the first content material of the first format into the first content material of the second format, creating single composite content including the first content material of the second format and second content material and delivering the thus-created composite content to the client terminal. Particularly, the present invention thus arranged can dramatically reduce the necessary storage capacity of the content material storage section.

What is claimed is:

1. A content delivery apparatus comprising:
a storage section that stores at least one first content material and at least one second content material to be delivered to a client terminal, said first content material being of a predetermined first format;
a client terminal identification section that determines a type of a client terminal to which content is to be delivered;
a first content creation section that, on the basis of a determination, by said client terminal identification section, that said client terminal to which content is to be delivered is of a type capable of using said first content material of said first format, creates single composite content to be delivered to said client terminal which includes said first content material of said first format and said second content material;
a second content creation section that, on the basis of a determination, by said client terminal identification section, that said client terminal to which content is to be delivered is of a type incapable of using said first content material of said first format, converts said first content material of said first format into a first content material of a second format capable of being used by said client terminal and then creates single composite content to be delivered to said client terminal which includes the converted first content material of said second format and said second content material; and
a content delivery section that delivers, to said client terminal, the composite content created by said first content creation section or said second content creation section.

2. A content delivery apparatus as claimed in claim 1 wherein said first content material is musical score data, and said second content material is music piece data.

3. A content delivery apparatus as claimed in claim 2 wherein the musical score data and the music piece data correspond to each other in musical contents.

4. A content delivery apparatus as claimed in claim 1 wherein said storage section stores a plurality of the first content materials and a plurality of the second content materials, and wherein at least one first content material and at least one second content material to be delivered to said client terminal are read out from said storage section in response to a request made by said client terminal.

5. A content delivery program for causing a computer of a content delivery apparatus, including a storage section storing at least one first content material of a predetermined first format and at least one second content material to be delivered to a client terminal, to perform:
an identification step of determining a type of said client terminal to which content is to be delivered;
a first content creation step of, on the basis of a determination, by said identification step, that said client terminal to which content is to be delivered is of a type capable of using said first content material of said first format, creating single composite content to be delivered to said client terminal which includes said first content material of said first format and said second content material;
a second content creation step of, on the basis of a determination, by said identification step, that said client terminal to which content is to be delivered is of a type incapable of using said first content material of said first format, converting said first content material of said first format into a first content material of a second format capable of being used by said client terminal and then creating single composite content to be delivered to said client terminal which includes the converted first content material of said second format and said second content material; and
a content delivery step of delivering, to said client terminal, the composite content created by said first content creation step or said second content creation step.

6. A content delivery apparatus comprising:
a storage section that stores at least one first content material and at least one second content material to be delivered to a client terminal, said first content material being of a predetermined first format;
a client terminal identification section that determines a type of said client terminal to which content is to be delivered;
a content creation section that, on the basis of a determination by said client terminal identification section about the type of said client terminal, converts said first content material of said first format into a first content material of a second format capable of being used by said client terminal and then creating single composite content to be delivered to said client terminal which includes the converted first content material of said second format and said second content material; and
a content delivery section that delivers, to said client terminal, the composite content created by said content creation section.

7. A content delivery apparatus as claimed in claim 6 wherein said first content material is musical score data, and said second content material is music piece data.

8. A content delivery apparatus as claimed in claim 7 wherein the musical score data and the music piece data correspond to each other in musical contents.

9. A content delivery apparatus as claimed in claim 6 wherein said storage section stores a plurality of the first content materials and a plurality of the second content materials, and wherein at least one first content material and at least one second content material to be delivered to said client terminal are read out from said storage section in response to a request made by said client terminal.

10. A content delivery program for causing a computer of a content delivery apparatus, including a storage section storing at least one first content material of a first format and at least one second content material, to perform:
an identification step of determining a type of said client terminal to which content is to be delivered;
a content creation step of, on the basis of a determination by said identification step about the type of said client terminal, converting said first content material of said first format into a first content material of a second format capable of being used by said client terminal and then creating single composite content to be delivered to said client terminal which includes the converted first content material of said second format and said second content material; and
a delivery step of delivering, to said client terminal, the composite content created by said content creation step.
